(19) United States
(12) Patent Application Publication
(10) Pub. No.: US 2016/0319837 A1
(43) Pub. Date: Nov. 3, 2016

(54) ACTIVE FLUTTER CONTROL OF VARIABLE PITCH BLADES

(71) Applicants: Robert J. MORRIS, Hartford, CT (US); Carroll V. SIDWELL, Hartford, CT (US); Coy B. WOOD, Hartford, CT (US); Charles R. LEJAMBRE, Hartford, CT (US); UNITED TECHNOLOGIES CORPORATION, Farmington, CT (US)

(72) Inventors: Robert J. Morris, Portland, CT (US); Carroll V. Sidwell, Wethersfield, CT (US); Coy B. Ellington, Ellington, CT (US); Charles R. Lejambre, New Britain, CT (US)

(21) Appl. No.: 15/103,817

(22) PCT Filed: Dec. 3, 2014
(86) PCT No.: PCT/US14/68450

§ 371 Date: Jun. 10, 2016

Related U.S. Application Data
(60) Provisional application No. 61/915,473, filed on Dec. 12, 2013.

(51) Int. Cl. F04D 29/36; F04D 29/66; F04D 29/38; F04D 27/00; F04D 29/32

(52) U.S. Cl. CPC F04D 29/362; F04D 27/002; F04D 29/323; F04D 29/324; F04D 29/325; F04D 29/38; F04D 29/668; F05B 2220/33; F05B 2260/96; F05B 2270/80; F05B 2270/404; F05B 2270/20

(57) ABSTRACT

A gas turbine engine includes a plurality of blades, a sensor configured to detect vibration on one or more of the plurality of blades, and a controller coupled to the sensor and configured to adjust a blade incidence upon an onset of vibration being detected by the sensor wherein the adjustment of the blade incidence reduces the vibration.

### CROSS-REFERENCE TO RELATED APPLICATIONS

This application claims priority to U.S. Provisional Application No. 61/915,473 filed on Dec. 12, 2013 and titled Active Flutter Control of Variable Pitch Blades, the disclosure of which is hereby incorporated by reference in its entirety.

### BACKGROUND

The present disclosure relates generally to gas turbine engine operation, and, more particularly, to avoiding vibration in fan blades of gas turbine engine.

At certain aircraft flight operating conditions, airfoils of gas turbine engine's fan and compressor blade encounter self-excited, non-integral vibrations (normally called flutter) which are induced by the interaction between adjacent blade airfoils in a rotor stage and can lead to very high blade displacements and stress, and result in cracking and fracture of the blade after a relatively few number of vibratory cycles. At these flight conditions, the combined interactions of vibratory modes, nodal diameters and operating conditions can produce destabilizing forces causing a fracture/failure of blades that may results in catastrophic failure of engine/propulsion system.

As such, what is desired is a system and method that can actively monitor and adjust operation conditions to avoid vibrations in fan and compressor blades.

### SUMMARY

Disclosed and claimed herein is a system and a method for avoiding vibration of fan and compressor blades in gas turbine engines. In one embodiment, the gas turbine engine includes a plurality of blades, a sensor configured to detect vibration on one or more of the plurality of blades, and a controller coupled to the sensor and configured to adjust a blade incidence upon an onset of vibration being detected by the sensor wherein the adjustment of the blade incidence reduces the vibration.

Other aspects, features, and techniques will be apparent to one skilled in the relevant art in view of the following detailed description of the embodiments.

### BRIEF DESCRIPTION OF THE DRAWINGS

The drawings accompanying and forming part of this specification are included to depict certain aspects of the present disclosure. A clearer conception of the present disclosure, and of the components and operation of systems provided with the present disclosure, will become more readily apparent by referring to the exemplary, and therefore non-limiting, embodiments illustrated in the drawings, wherein like reference numbers (if they occur in more than one view) designate the same elements. The present disclosure may be better understood by reference to one or more of these drawings in combination with the description presented herein. It should be noted that the features illustrated in the drawings are not necessarily drawn to scale.

FIG. 1 schematically illustrates a gas turbine engine.

FIG. 2 illustrates a blade sensing and control system for avoiding vibration on the blade according to an embodiment.

FIG. 3 is a process flow illustrating a method for avoiding fan blade vibration according to an embodiment.

### DESCRIPTION

One aspect of the disclosure relates to fan and compressor blade vibration avoidance in gas turbine engines. Embodiments of the present disclosure will be described hereinafter with reference to the attached drawings.

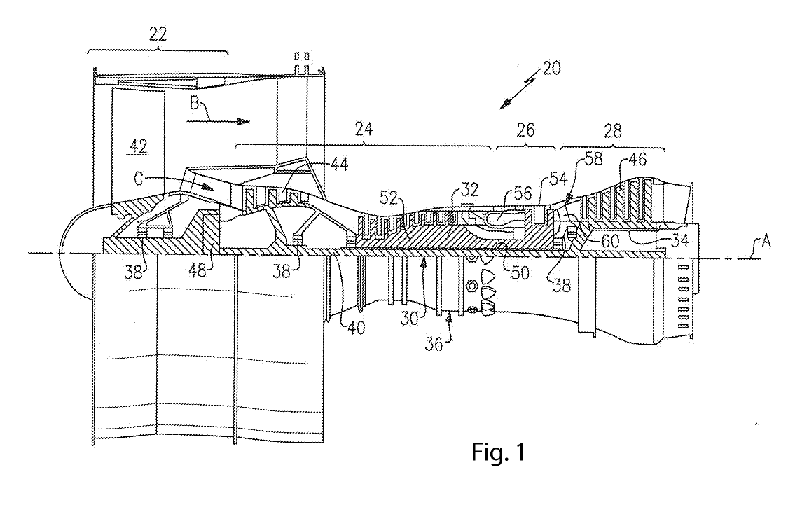

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]0.5. The “Low corrected fan tip speed” as disclosed herein according to one non-limiting embodiment is less than about 1150 ft/second.

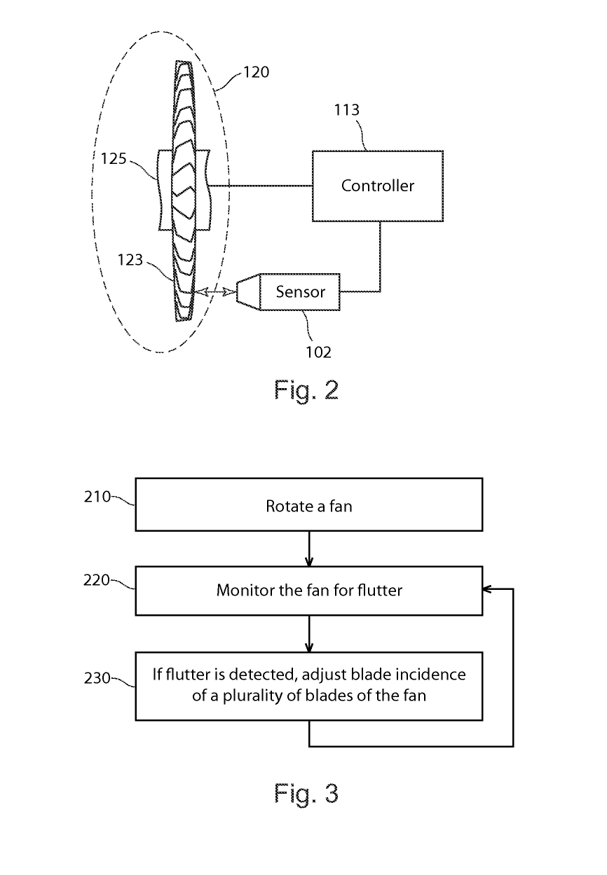

FIG. 2 illustrates a blade sensing and control system for avoiding vibration on the blade according to one embodiment of the present disclosure. The vibration avoidance system includes a sensor 102 and controller 113 serving a limited variable pitch (LVP) fan 120. The LVP fan 120 includes a plurality of fan blades 123 mounted on a spool 125, which houses a blade pitch adjustment mechanism (not shown). Upon detecting an onset of a vibration, the vibration avoidance system will adjust one or more parameters to allow the fan 120 to return to a non-flutter operating environment according embodiments of the present disclosure. Fan blade incidence is one of such parameters that can be adjusted to avoid the fan blade vibration, as fan blade incidence is an aerodynamic parameter that causes flutter instabilities. Stalled incidence reduces aerodynamic dampening below what is required for flutter free operation. The operating incidence of the fan blade 123 may be adjusted by changing the blade pitch, injecting air locally at fan blade tip, and slewing variable area fan nozzle to change the engine operating condition, any of which may also be parameters.

Generally, when a fan blade incidence is too high for a given operating condition, flutter on the fan blades 123 may occur. Closing or reducing the fan blade incidence will move the fan blade flutter conditions away from the fan blade operating line, allowing the fan 120 to operate in non-flutter environment.

However, when the fan blades 123 are always rotated at lower incidence, there will be a net penalty on engine performance, and hence lowering fan blade incidence should be performed when it is necessary to avoid vibration. In one embodiment, the controller 113 is a part of an overall engine control (not shown) with an optimum fan blade schedule in its engine control logic. The controller 113 monitors and adjusts the fan blades 123 in order to keep the engine operating in a flutter-free, yet optimized condition throughout the flight envelop.

Referring again to FIG. 2, the sensor 102 monitors the fan blades 123. When an onset of a flutter on the fan blades 123 is detected, the sensor 102 will transmit the information to the controller 113, which will then start to reduce the incidence of the fan blades 123 until the flutter is eliminated. In one embodiment, the sensor 102 is what is commonly known as time-of-arrival or non-interference stress measurement system (NSMS) mounted on a case (not shown) that houses the LVP fan 120. The sensor 102 detects the passing of the blade tip past a stationery reference point on the case (where they are mounted). Blade tip arrival time (or the change in time from the expected and actual arrival times) is converted into displacement and stress. When the displacement and stress value is higher than a certain threshold value, a flutter is then detected by the sensor 102. It should also be appreciated that when a small, lightweight and self-powered sensor with telemetry is used, the sensor can be mounted on the blades 123. Other types of sensors, such as radar and pressure sensors, may also be used to detect the blade vibration.

Although the present disclosure uses the LVP fan 120 as an example, those of ordinary skill in the art will understand that vibration may occur in other types of blades such as compressor blades, and such vibration can be similarly eliminated according to embodiments of the present disclosure.

Although reducing fan blade incidence is exemplarily described in detail as a way to eliminate flutter, in other embodiments, a flutter can be eliminated by adjusting other engine operating parameters. One of such parameters is among mechanical properties of airfoil of the engine. Upon an onset of a flutter, the vibration avoidance system according to embodiments of the present disclosure may add mechanical damping to change the airfoil for eliminating the flutter. Piezo electrical dampers can be dispatched for such mechanical damping.

FIG. 3 is a process flow illustrating a method for avoiding fan blade vibration according to an embodiment. At block 210, a fan is rotated. At block 220, the sensor 102 monitors the fan for flutter. In an embodiment, the sensing may be performed by time-of-arrival measurement. At block 230, if flutter is detected, blade incidence of a plurality of blades of the fan will be adjusted. At the same time the sensor 102 continues monitoring the fan and causing further adjustment of the blade incidence until the flutter condition is cleared.

While this disclosure has been particularly shown and described with references to exemplary embodiments thereof, it shall be understood by those skilled in the art that various changes in form and details may be made therein without departing from the spirit of the claimed embodiments.

What is claimed is:

1. A gas turbine engine comprising:
a plurality of blades;
a sensor configured to detect vibration on one or more of the plurality of blades; and
a controller coupled to the sensor and configured to adjust a parameter of the gas turbine engine upon an onset of vibration being detected by the sensor,
wherein the adjustment of the parameter causes reduction of the vibration.

2. The gas turbine engine of claim 1, wherein the controller is configured to maintain the gas turbine engine operating in an optimized condition.

3. The gas turbine engine of claim 1, wherein the sensor is a case-mounted time-of-arrival sensor.

4. The gas turbine engine of claim 1, wherein the parameter is an incidence of the plurality of blades.

5. The gas turbine engine of claim 4, wherein the incidence is adjusted by changing a blade pitch.

6. The gas turbine engine of claim 4, wherein the incidence is adjusted by injecting air locally at a blade tip.

7. The gas turbine engine of claim 4, wherein the incidence is adjusted by slewing a variable area fan nozzle.

8. The gas turbine engine of claim 1, wherein the parameter is one of the mechanical properties of airfoil of the gas turbine engine.

9. The gas turbine engine of claim 8, wherein the one of the mechanical properties of airfoil is changed by dispatching additional mechanical dampers.

10. A gas turbine engine comprising:
a sensor configured to detect vibration on one or more of a plurality of blades; and
a controller coupled to the sensor and configured to adjust a blade incidence of the plurality of blades upon an onset of vibration being detected by the sensor and to continue to adjust the blade incidence of the plurality of blades until the vibration being eliminated.

11. The gas turbine engine of claim 10, wherein the sensor is a case-mounted time-of-arrival sensor.

12. The gas turbine engine of claim 10, wherein the blade incidence is adjusted by changing a blade pitch.

13. The gas turbine engine of claim 10, wherein the blade incidence is adjusted by injecting air locally at a blade tip.

14. The gas turbine engine of claim 10, wherein the blade incidence is adjusted by slewing a variable area fan nozzle.

15. The gas turbine engine of claim 10, wherein the controller is configured to maintain the gas turbine engine to operate at an optimized condition.

16. A method of operating a gas turbine engine, the method comprising:
sensing one or more of a plurality of rotating blades;
detecting flutter on at least one of the plurality of blades; and
adjusting a blade incidence of the plurality of blades in response to detecting a flutter.

17. The method of claim 16, wherein the sensing includes performing time-of-arrival measurement.

18. The method of claim 16, wherein the adjusting blade incidence includes changing a blade pitch.

19. The method of claim 16, wherein the adjusting blade incidence includes injecting air locally at a blade tip.

20. The method of claim 16, wherein the adjusting blade incidence includes slewing a variable area fan nozzle.
